(19) United States
(12) Patent Application Publication
(10) Pub. No.: US 2006/0025223 A1
(43) Pub. Date: Feb. 2, 2006

(54) Gaming information center

(76) Inventor: Oscar Ray Lewis, Tukwila, WA (US)

Correspondence Address: BLACK LOWE & GRAHAM, PLLC, 701 FIFTH AVENUE, SUITE 4800, SEATTLE, WA, 98104, US

(21) Appl. No.: 11/129,037

(22) Filed: May 13, 2005

Related U.S. Application Data
(60) Provisional application No. 60/570,885, filed on May 13, 2004.

(51) Int. Cl. A63F 13/00

(52) U.S. Cl. 463/43

(57) ABSTRACT

A method for displaying gambling information in order to improve customer service by displaying a screen of all possible requests by the customer sorted by request and then by area and table number. This is accomplished by allowing a user to enter data through an input device designed to write directly to the program. Then manipulating the information to determine to which area of the information center it applies. Once the program deciphers the correct destination, it connects to the attached database and writes the information to a corresponding table. The system then displays the information in a table format allowing the user to see all requests and hands dealt in the predetermined universe.

### PRIORITY CLAIM

This application claims priority to U.S. Provisional Application Ser. No. 60/570,885 filed May 13, 2004, incorporated by reference in its entirety herein.

### FIELD OF THE INVENTION

This invention relates generally to monitoring one or more variables in the gaming or gambling and, preferably for improving overall customer service and tracking dealer statistics in a gaming or gambling environment.

### BACKGROUND OF THE INVENTION

The level of customer service in casinos is falling because dealers have more things to remember. Also, the rise in popularity of poker brings large groups of people to card rooms and currently there is not a system to manage players effectively. At present requests from customers are memorized by the dealers or written down by floor managers, leading to mishaps in communication and a lack of reliability.

Dealers forget to pass along requests from the players and this causes a great amount of frustration from the player. For example if a player asks to move seats a dealer must keep this information in her head; however this information can become easily jumbled with other players requests. In these cases the players become upset and may leave the casino.

Another problem includes players who take extended breaks from the table. Without a running clock a dealer may forget the exact time a player has been away. This upsets all other players as it may affect the odds and other aspects of the game. Currently there is not an automated way to track how long players are away.

Further in a loud casino it is hard to obtain the attention of a service person or a floor manager, therefore delaying a customer's total enjoyment of the experience.

Finally on a casino-wide scale a player may desire to move to a new table and currently it is not possible for a dealer to efficiently and easily monitor the whole floor in order to grant this request. Currently a player must give up his seat and search the floor for a seat at a table that is more enjoyable. During this time a customer is not happy and the casino is not maximizing their profits.

### SUMMARY OF THE INVENTION

A device, method and/or system for collecting, managing and/or displaying information related to gaming, such as, for example, a poker game.

### BRIEF DESCRIPTION OF THE DRAWINGS

Preferred and alternative embodiments of the present invention are described in detail below with reference to the following drawings.

FIG. 1 illustrates a line drawing replicating a screen shot of one embodiment of the present invention;

FIG. 2 illustrates a flow chart showing the path of inputted data as it is stored in a database;

FIG. 3 is a flow chart showing the steps to continuously display data onto a graphical user interface;

FIG. 4 illustrates a system for inputting and displaying the RayLo Information Center in accordance with an embodiment of the present invention;

FIG. 5 illustrates a face view of one embodiment of a seat change indicator which has been prototyped using a small plastic housing with removable face, and which shows buttons which may be pressed to indicate seat move requests, and a display for indicating a seat move sequence;

FIG. 6 illustrates a perspective view of one embodiment of a seat change indicator using the configuration first shown in FIG. 5, now more fully indicating the relative dimensions of one embodiment for such a device;

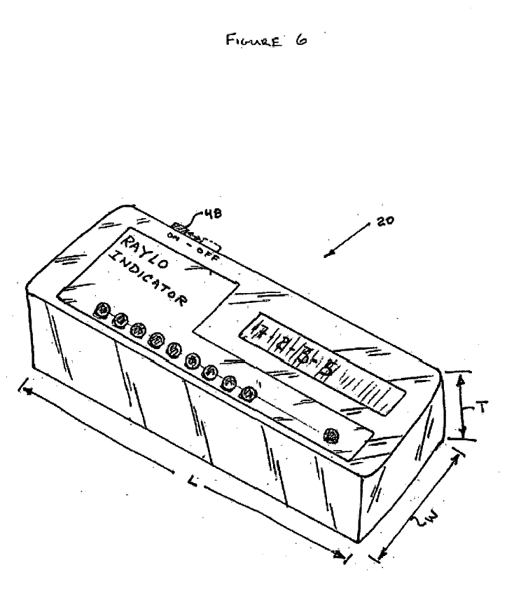

FIG. 7 illustrates top view, taken looking down at an embodiment of a seat change indicator;

FIG. 8 provides a view of the interior of the circuitry of an embodiment of seat change indicator;

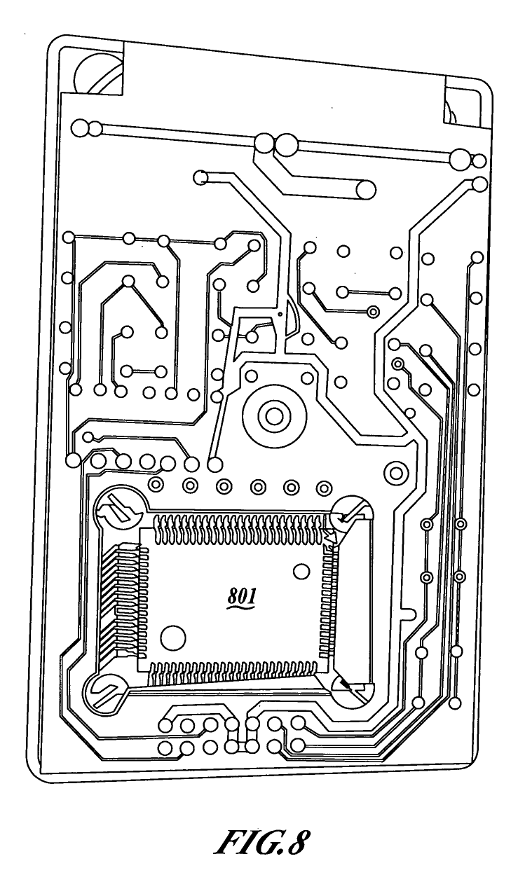

FIG. 9 shows the electrical schematic for one embodiment of a portable, battery powered seat change indicator, illustrating how a plurality of switches are utilized to sequentially illuminate a display which, in turn provides a sequence of integers corresponding to switches activated in the electrical circuit; and,

FIG. 10 illustrates the functional elements for a portable, mechanical seat change indicator, indicating how a plurality of movable indicator faces can be positioned in sequence to show a series of seat move requests by card players; and,

FIG. 11 illustrates one embodiment of a device that may sit at a table and then transmit to the information center.

### DETAILED DESCRIPTION OF A PREFERRED EMBODIMENT

Preferred embodiments of the present invention provide improved methods, systems and devices relating to communication related to gaming. The information that may be included is comprised of one or more of, or any combination of, the following: floor manager calls, seat move requests, time outs taken, high/lows, overs, table change requests, service requests and other gaming related communication topics. In order to accomplish this task, data is inputted into the computer system by a user or directly from a table. After the data has entered the system, the data is validated and then placed into a function to determine what kind of data was entered. Data is sorted and stored in a corresponding database table. When data is entered into a database a display function may be activated retrieving the data and placing into its correct location on a graphical user interface. It is on this display that a manager can watch all of the customer service functions of a card room and ensure all customers are receiving maximum customer service and enjoyment. In one embodiment the system may track the numbers of hands being played at all tables throughout the casino. In accordance with still further aspects of some embodiments, an activity log may run along the bottom to show complete text of all actions sent to the program, preferably throughout a given time.

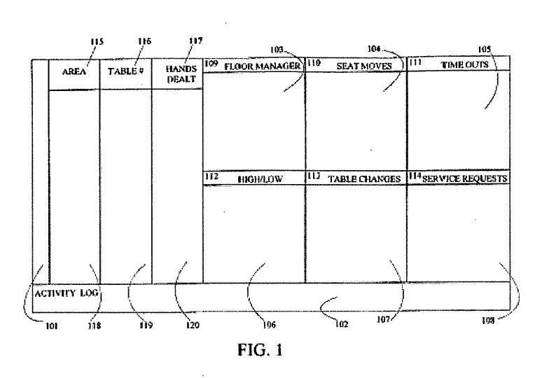

FIG. 1, illustrates a line drawing replicating a screen shot of one embodiment of the present invention. The screen shot consists of a title bar 115 containing the text, casino area number, and below 118 is 115 consisting of a column of numbers representing different areas of the casino. The casino area number may result from dividing the room into particular areas, possibly these areas would be monitored by different managers. Immediately next to it is the title bar 116 entitled table number, and below is a column of numbers representing particular table numbers 119. Tables 118 and 119 are connected to form a casino area and a table number pinpointing a table out of a large casino. In addition the shot shows title bar 117, hands dealt, and a column below displaying the number of hands dealt 120 as it relates to the corresponding area number and table number. These columns allow the numbers to line up in rows showing, area number, table number and total hands dealt. This may be used to track dealer performance and efficiency.

FIG. 1 further describes a section of the screen divided into six equal tables 103-108. These tables may display the discrete features of a preferred embodiment: floor manager call center, seat move tracker, time outs, high/lows, table changes, and service requests.

The floor manager table 103, includes a title bar 109, and may display two columns of information showing the area number and table number where a floor manager is needed. This allows a manager to know what tables need assistance and in what order to visit those tables. In an alternate embodiment the manager may also track the time a table has been waiting for the manager; or the reason a floor manager is needed

Table 104 may be the table that tracks the seat moves on a global basis. It further includes a title 110. The information stored and displayed in this table may consist of the area number, table number and the seat number. This allows a manager to track the list of people who wish to move seats. The manager then may choose the person at the top of the list and then alert the dealer as to which player may move seats.

Further displayed is the time out counter 105 and title bar 111. The time out counter may display an area number, table number, seat number and time remaining. This feature can track the time a player has been away from the table and may allow for the particular manager to set a policy of how long a player is permitted be away from the table before losing their seat. Also, each row of information may be color coded in order to show the user a visual status indicator on time remaining.

Next, in one embodiment, the High/Lows are displayed in 106 and include a title bar 112. This may track an area number, table number, seat number and chip count. This allows a manager to see who has what in chips and can make decision that may include raising the “blinds” or initial player buy-ins.

The table change display area, in one embodiment, includes a title bar 113 and displays requests in box 107. The table may include an area number, table number and seat displayed in a list format to show who is waiting to move to a new table. This may allow a manager to look at all tables in the casino and decide if there is a space to move the player that has requested to be moved.

Also included, in one embodiment, is a service request table 108 and corresponding title bar 114. This table may display an area number, table number and seat number, which corresponds to who has requested service. This implies that a manager would then be able to direct a member of the wait staff to that location, and bring satisfaction to the customer. This table may also include a time the user has been waiting and also possibly what the user is requesting.

Also included in FIG. 1 is a row along the bottom 102, which may display all actions reported to the system in a text box format. This text box can scroll through all events, which may be sorted by time. This information may be cleared or it may last for a length of time specified by the user.

On the left side of FIG. 1 may be an area for menu buttons 101. This area can add functionality by allowing a user to access other areas of the program or other features that may relate to the program.

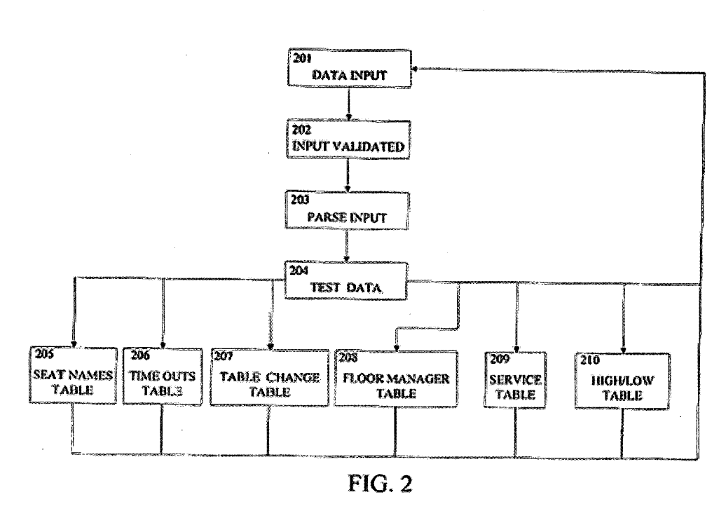

FIG. 2 is a flow chart showing the path of inputted data as it is stored in a database, in one embodiment. Data is inputted into the system 201. The data is then validated 202, this step tests that all information was entered with the correct syntax. The data is then parsed 203 using a preset method to break the data into separate variables. Once parsed, the data is then tested for accuracy 204. This test may include checking the area number and table number to see if they exist within the system. The next step of the test is to determine the destination which may be represented as a variable entered during the initial input. Once the system determines the destination of the data, the data is sent through a database connection and stored in the corresponding table. These tables may include: seat moves 205, timeouts 206, table changes 207, floor manager 208, service calls 209, and high/lows 210. Once the data is stored the system then looks for another set of input from the user.

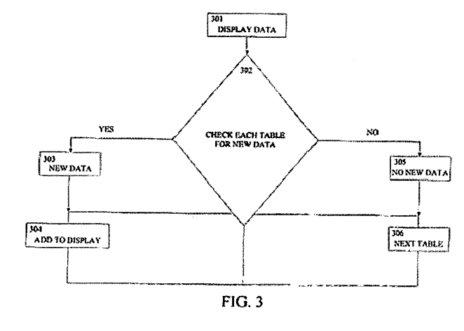

FIG. 3 is a flow chart showing preferred steps to continuously display data onto a graphical user interface. The function, display data 301, is called after an action has been performed within the system, in one embodiment. It may be after data has been entered or deleted. The program needs to constantly updated in order for the data to be accurate, so after ever function call within the program, the program should display the updated data. After display data 301 is called, in one embodiment of the system, the system loops through each database table and tests for new data 302, if new data 303 is found then the information is displayed 304, however, if the there is no new data 305 then the program cycles to the next table 306.

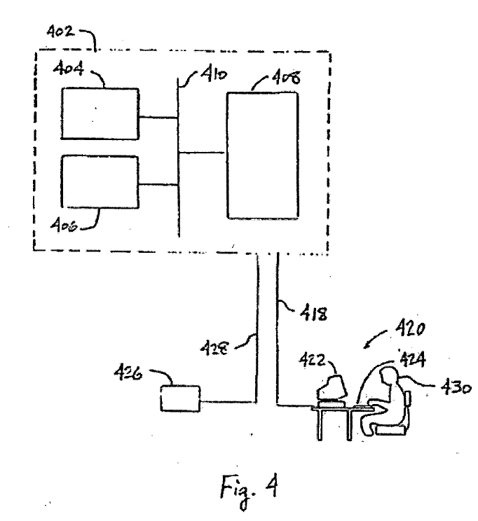

FIG. 4 is a system 400 for displaying the information in accordance with one embodiment of the device. The significant details and aspects of the system 400 can be described. As shown in FIG. 4, in this embodiment, the system 400 includes a computer 402 having a central processing unit (CPU) 404 and a memory component 406. The memory component 406 may include one or more memory modules, such as Random Access Memory (RAM) modules, Read Only Memory (ROM) modules, Dynamic Random Access Memory (DRAM) modules, and any other suitable memory modules. The computer 402 also includes an input/output (I/O) component 408 that may include a variety of known I/O devices, including network connections, video and graphics cards, disk drives or other computer-readable media drives, displays, or any other suitable I/O modules. A data bus 410 operatively couples the CPU 404, memory component 406, and the I/O component 408.

As further shown in FIG. 4, the system 400 further includes a control component 420 having a monitor 422 and a command input device 424 (e.g. a keyboard, an audio-visual input device, etc.). A second communication link 418 operatively couples the control component 420 to the computer 402. The system 400 also includes an auxiliary output device 426 coupled to the computer 402 by a third communication link 428. The auxiliary output device 426 may include a printer, a compact disk (CD) burner, a storage device, a communication port, or any other desired output device.

In one aspect, a machine-readable medium may be used to store a set of machine-readable instructions (e.g. a computer program) into the computer 402, wherein the machine-readable instructions embody a method of inputting and displaying customer service information in accordance with the teachings of the present invention. The machine-readable medium may be any type of medium which can store data that is readable by the computer 402, including, for example, a floppy disk, CD ROM, optical storage disk, magnetic tape, flash memory card, digital video disk, RAM, ROM, or any other suitable storage medium. The machine-readable medium, or the instructions stored thereon, may be temporarily or permanently installed in any desired component of the system 400, including, for example, the I/O component 408, the memory component 406, and the auxiliary output device 426. Alternately, the machine-readable instructions may be implemented directly into one or more components of the computer 402, without the assistance of the machine-readable medium.

In operation, the computer 402 may be configured to perform one or more of the aspects of the methods of inputting and displaying gaming information. For example, an operator 430 may input a string through the command input device 424 to cause the system to display one or more blocks of data stored in the database 301 (FIG. 3). The computer 402 may be configured to perform the methods of displaying the test data sets. For example, a set of software instructions may be stored in the computer 402 (e.g. in the memory component 406) that causes the data to be displayed into the display component 42 and processed using the CPU 404 in accordance with one or more methods of displaying data, including one or more of the processes described above with respect to FIGS. 1-3. Alternately, one or more aspects of the various processes described above may be implemented in the computer 402 using any suitable programmable or semi-programmable hardware components (e.g. EPROM components).

In a preferred embodiment this device may be operated on a computer implemented by a set of software code designed to run on that particular machine. However it may also run on a personal digital assistant, portable LCD screen or other display means. Also in an alternate embodiment the display function may also send the data to a wall television display for customers to see all of the pertinent information. In one embodiment the system may also hold a waiting list so as to track who gets to play next when there is an open seat.

In one embodiment of the present invention there may be a system for entering and receiving information at a table. The device may transmit information as a stand alone unit or as a piece of another system already installed. The system can allow a dealer to enter information at a table and transmit that to the information center. Also the dealer can send updates to the system to display information pertinent to the dealer. The table based device and information center may be connected through a LAN, wireless LAN, or other communication means. In one embodiment the information center may be able to receive wired or wireless transmissions.

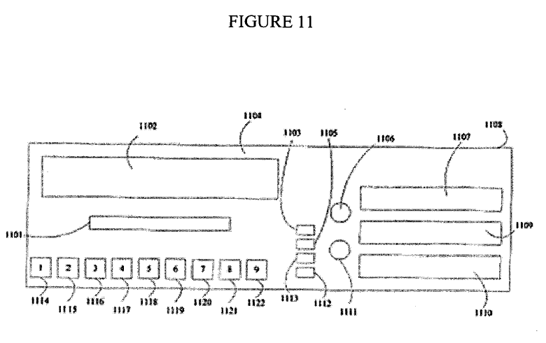

FIG. 11 illustrates one embodiment of a device that may sit at a table and then transmit to the information center. One embodiment may include 1101 an input screen in order to view the entries made before entering them into the system. A queue displaying the list of seat move requests 1102. A series of keys to enter data, with the input of flagging them as to there purpose (Seat Move 1103, Dealer Number 1104, Table Move 1113, Hands Completed 1112). There may be two button to call for a service person 1106 and a manager 1111. Also there may be boxes to display a player number next to a countdown timer showing the dealer how long a player has been away 1108-10. Finally a series of input keys are included 1114-23. This device may be linked via wireless or a wired connection 1108.

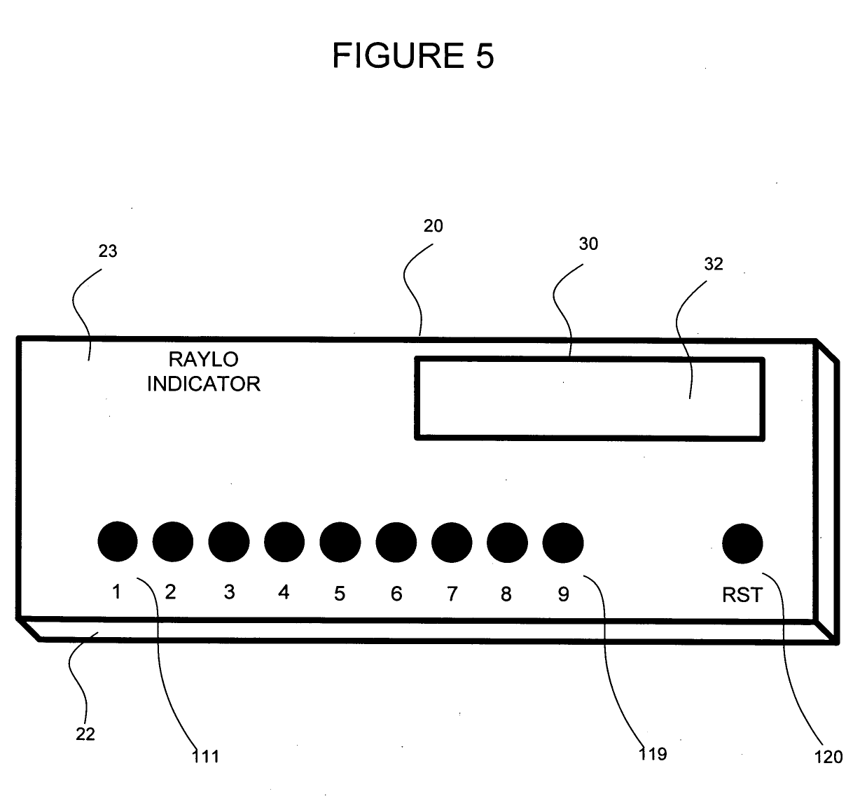

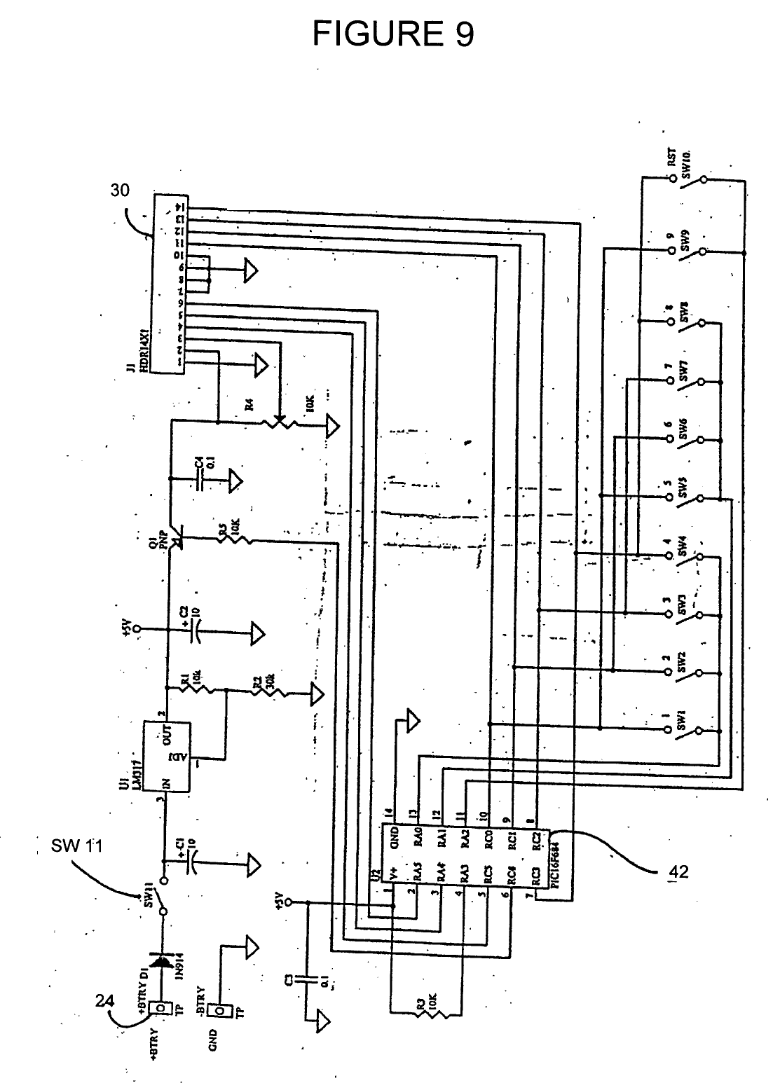

The physical appearance for one embodiment for a useful seat change indicator 20 is provided in FIG. 5. A molded plastic housing 22 is provided with a removable face portion 23. An electrical power supply source such as a battery 24 (see FIG. 9) is provided. In one embodiment, it has been found useful to provide two AAA size batteries to power the seat change indicator 20. A plurality of switches SW₁ through SW₉ are provided, as better seen in FIG. 9, with each switch having a number corresponding to a number designated at a table in a gambling establishment. An electrically driven optical display 30 is provided, such as by a liquid crystal display. The optical display 30 includes a plurality of display fields 32 in a spaced apart fashion, indicated by squares shown in FIG. 51 (for illustrative purposes), wherein a series of integers from 1 to N in a series of integers (or other differentiating indicia in a series of indicia such as numbers, letters, or other symbols in other languages). A reset switch SW₁₀ is also provided. A signal generated by pressing any one of switches SW₁ through SW₉ is processed by microprocessor 42 to send a signal to optical display that results in the display of an integer (or other equivalent indicia) at a cursor location (indicated by the rectangle 44 on the optical display 30. An on-off switch SW₁₁ is provided to turn the on or off the supply of electrical power to the indicator 20.

Although dimensions of the seat change indicator 20 can be varied to suit the end user environment, display size desirability, as well as to meet manufacturing cost requirements, in one embodiment, it has been found useful to provide indicator 20 substantially in the shape of a parallel piped having a length L of about 4.5 inches, a width W of about 2.25 inches, and a thickness T of about 0.6 inches.

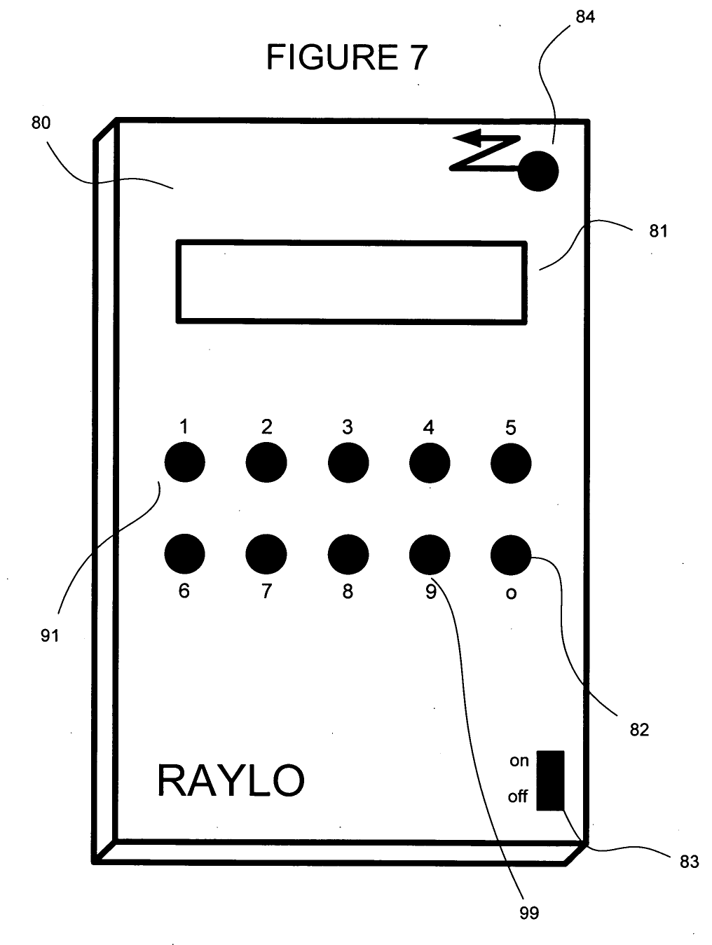

Operation of the seat change indicator 20 is straightforward. The on-off switch SW₁₁ is activated to power up the optical display 30. However, at time of power up, the display is blank, since no seat numbers have been input at time of initial power supply. When any one of key switches SW₁ through SW₉ are pressed (each of key switches SW₁ through SW₉ correspond to a particular gaming table seat), then immediately upon pressing of said selected key switch, a number corresponding to said just pressed selected key switch is displayed next to the cursor; Upon subsequent pressing of a key switch, previously indicated numbers are moved across the display one numerical position, normally (but not necessarily) to the left as in the embodiment described herein. Various of the key switches SW₁ through SW₉ are pressed when desired to indicate that a player in any one of corresponding gaming table seats 1 through 10 have requested that they be placed in line for a seat move. Thus, keys SW₁ through SW₉ may be pressed in any desired sequence, although since each occupied seat can result in the corresponding key switch being pressed, and thus displayed, at any one time. In one embodiment, the plurality of different key switches pressed represents a series of integers from 1 to N which are displayed on the optical display 30. In one embodiment, up to 10 different key switches may be provided (one more than shown in FIGS. 7 or 9, where an embodiment showing N=9 is illustrated.

Also, an indicator 20 may be provided with a reset switch (shown as RST/SW10) in FIG. 9, or as “RST” in FIG. 5. Upon activation of the reset key, the number displayed adjacent to the cursor is removed. Then, upon removal of the number adjacent to the cursor, all other numbers displayed move sequentially one position toward the cursor. As noted above, such movement of the numbers displayed is normally one position to the left.

For saving of batteries, in one embodiment, the optical display is turned off after a selected elapsed time period during which no key switch is pressed. In one embodiment, such elapsed time may be a period of five minutes. In such a configuration, after the optical display is turned off, a first pressing said reset key can turns the optical display back on. For preservation of data, the microprocessor stores the sequence of key switch operation. Then, after the optical display has been turned on, subsequent pressing of the reset key can be used to delete displayed integers sequentially, one at a time, oldest entry first. Further, in one embodiment, using the on-off switch 48 to turn off the indicator 20 turns off optical display 30, but preserves data indicating a sequence of integers as entered by the user. Then, merely turning on the indicator, and thus the optical display, the device again displays the stored sequence of integers corresponding to seat move requests.

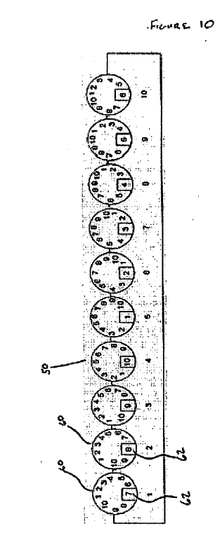

In yet another embodiment, a mechanical version 50 may be provided as shown in FIG. 10. A plurality of wheels can be provided on a base. The wheels have a stable or latchable position wherein a specific integer can be selected corresponding to a player's seat number at a gaming table. Wheels 60 can be positioned so that in windows 62, a series of seat numbers are indicated. The seat numbers in windows 62 can be read from right to left, or left to right, as desired by the user. The mechanical details are fairly simple, but certain aspects may be advantageously provided by the device depicted in U.S. Pat. No. 6,762,334, issued June 1998 to Kosi, which is incorporated herein in its entirety by this reference.

Preferred embodiments provide a method for displaying gambling information in order to improve customer service comprising one or more of the following steps: entering data through an input medium designed to write directly to a program; validating the information as its entered by using pre determined test to check for length and character type entered; parsing the information into preset lengths and storing them into variables in order to decipher the destination of the information; instituting connecting to a database using database connection protocols; writing the information into a predetermined table; and, displaying that information to a screen in order to constantly show the user what is happening throughout a casino.

Other preferred embodiments provide an indicator, comprising: a housing; an electrical power supply source; a microprocessor; an electrically driven optical display, said optical display configured for display, in spaced apart fashion, a sequence of integers; one or more numbered switches configured to drive, via said microprocessor, display of a sequence of integers, said sequence of integers corresponding to a sequence of operations performed on said discretely numbered switches in said one or more switches. Said switches in some embodiments further comprise an on-off switch to switch said electrical power supply source on or off. In some embodiments, the electrical power supply source comprises battery power, preferably one or more AAA batteries, although any kind of battery may be used.

In one preferred embodiment, the housing comprises molded plastic, preferably with a removable face portion with an optical display.

The housing may be of any size or shape. In one preferred embodiment, the housing substantially comprises a parallelepiped structure approximately 4.5 inches in length. In one preferred embodiment, the housing substantially comprises a parallelepiped structure approximately 2.25 inches in width. In one preferred embodiment, the housing substantially comprises a parallelepiped structure approximately 0.6 inches thick.

One preferred embodiment provides a method of operating a numerical indicator comprising one or more, or any combination, of the following steps:
(a) providing an electrically powered numerical indicator having an optical display with a plurality of integer display locations;
(b) at power up, providing a blank display at each of said integer display locations;
(c) pressing a selected key switch, said selected key switch corresponding to one of a set of key switches representing a set of integers corresponding to seat numbers;
(d) immediately upon pressing of said selected key switch, displaying a number corresponding to said just pressed selected key switch next to the cursor;
(e) upon subsequent pressing of a key switch, moving previously indicated numbers across the display one numerical position.
   In one preferred embodiment, the method further comprises pressing a plurality of different key switches in sequence, preferably comprised of a series of integers from 1 to N. In one embodiment, N equals 10.
   In one preferred embodiment, the method further comprises providing an indicator having a reset key, and wherein upon activation of said reset key, the number displayed adjacent to the cursor is removed.
   In one preferred embodiment, upon removal of said number adjacent to said cursor, all other numbers displayed move sequentially one position toward said cursor. In one preferred embodiment, the method further comprises movement of said numbers displayed one position to the left.
   In one preferred embodiment, said optical display is turned off after a selected or otherwise determined elapsed time period during which no key is pressed. In one preferred embodiment, said selected elapsed time period is five minutes. In one preferred embodiment, said optical display is turned off, a first pressing said reset key turns said optical display on.
   In one preferred embodiment, said optical display has been turned on, subsequent pressing of said reset key deletes displayed integers one sequentially, on at a time, oldest entry first.
   In one preferred embodiment, said indicator comprises an on-off key, and wherein turning said indicator off turns off said optical display but preserves data indicating a sequence of integers as entered by the user, and wherein turning said indicator on displays the stored sequence of integers. See also Appendix 1.

While preferred embodiments of the invention have been illustrated and described, as noted above, many changes can be made without departing from the spirit and scope of the invention. Accordingly, the scope of the invention is not limited by the disclosure of a preferred embodiment. Instead, the invention should be determined entirely by reference to the claims that follow.

The embodiments of the invention in which an exclusive property or privilege is claimed are defined as follows:

1. A method for displaying gambling information comprising:
entering gaming-related information onto a system through an input medium;
writing the information into a database; and
displaying that information to a screen.

2. The method of claim 1 wherein the step of entering the information through an input medium further comprises entering the information with use of a keyboard, mouse or other computer input mechanism.

3. The method of claim 1 wherein the step of entering the information through an input medium further comprises entering the information through a remote device and transmitting the information through a transmission device

4. The method of claim 3 wherein the step of entering the information through a remote device and transmitting the information through a transmission device further comprises entering the information onto a remote computer and transmitting the information wirelessly.

5. The method of claim 1 further comprising validating the information.

6. The method of claim 1 further comprising running a set of instructions to establish a connection with the database.

7. The method of claim 1 wherein the step writing the information into a database further comprises using a preset variable as a signal as a way to determine where the information should be written.

8. The method of claim 1 wherein the step of displaying the information further comprises displaying the information in a table format.
